(19) United States
(12) Patent Application Publication
(10) Pub. No.: US 2022/0286853 A1
(43) Pub. Date: Sep. 8, 2022

(54) MOBILITY MANAGEMENT FOR AGGRESSIVE DEVICES

(71) Applicant: AT&T Intellectual Property I, L.P., Atlanta, GA (US)

(72) Inventor: Yaron Koral, Cherry Hill, NJ (US)

(21) Appl. No.: 17/190,495

(22) Filed: Mar. 3, 2021

(51) Int. Cl. H04W 12/08; H04W 12/121

(52) U.S. Cl. CPC H04W 12/08; H04W 12/121

(57) ABSTRACT

Mobility management for aggressive devices is provided. A method can include detecting a signaling event frequency associated with network equipment operating as part of a communication network; in response to the signaling event frequency being determined to be greater than a frequency threshold, classifying the network equipment as aggressive network equipment; and in response to classifying the network equipment as aggressive network equipment, assigning the network equipment to a first mobility management function of the communication network, wherein the first mobility management function accepts a first proportion of first network attach requests received by the first mobility management function from the network equipment, the first proportion being lower than a second proportion of second network attach requests accepted by a second, distinct mobility management function that serves other, non-aggressive network equipment.

### TECHNICAL FIELD

The present disclosure relates to wireless communication systems, and, in particular, to techniques for access control in a wireless communication system, e.g., for aggressive devices.

### BACKGROUND

Advancements in mobility network technology, such as the introduction of Fifth Generation (5G) wireless networks, have enabled support for an increasing number of devices as well as an increasing variety of device types. As the number and variety of devices utilizing a network increases, the probability that one or more network devices may act aggressively toward the network, e.g., due to bugs or faults in the hardware, software, and/or configuration of the devices, can similarly increase. By way of example, a faulty device can initiate a large number of signaling events that may overload the network. Additionally, these faults could be exploited by malicious users to create the effect of a distributed denial of service (DDoS) attack on the network and/or otherwise disrupt normal network service.

### DESCRIPTION OF DRAWINGS

FIG. 1 is a block diagram of a system that facilitates mobility management for aggressive devices in accordance with various aspects described herein.

FIG. 2 is a block diagram that depicts the functionality of the network management device of FIG. 1 in further detail in accordance with various aspects described herein.

FIG. 3 is a block diagram of a system that facilitates implementation of a mobility management function for aggressive devices in a wireless communication network in accordance with various aspects described herein.

FIGS. 4-5 are block diagrams of respective systems that facilitate assignment of network equipment to a mobility management function via a domain name system in accordance with various aspects described herein.

FIG. 6 is a block diagram that depicts the aggressive device detection and reassignment module of FIG. 3 in further detail in accordance with various aspects described herein.

FIG. 7 is a diagram that depicts example network functions that can be utilized in combination with a mobility management function in a fifth generation (5G) communication network in accordance with various aspects described herein.

FIG. 8 is a block diagram of a system that facilitates caching of network access requests transmitted by aggressive network equipment in accordance with various aspects described herein.

FIG. 9 is a block diagram of a system that facilitates computation and assignment of a time delay in connection with access class barring in accordance with various aspects described herein.

FIG. 10 is a block diagram of a system that facilitates detection and mitigation of malicious communication network activity in accordance with various aspects described herein.

FIG. 11 is a flow diagram of a method that facilitates mobility management for aggressive devices in accordance with various aspects described herein.

FIG. 12 depicts an example computing environment in which various embodiments described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring certain aspects.

In an aspect, a method as described herein can include detecting, by a system including a processor, a signaling event frequency associated with network equipment operating as part of a communication network. In response to the signaling event frequency being determined to be greater than a frequency threshold, the method can further include classifying, by the system, the network equipment as aggressive network equipment. In response to classifying the network equipment as aggressive network equipment, the method can include assigning, by the system, the network equipment to a first mobility management function of the communication network. The first mobility management function can accept a first proportion of first network attach requests received by the first mobility management function from the network equipment, where the first proportion is lower than a second proportion of second network attach requests accepted by a second mobility management function, distinct from the first mobility management function, that serves other network equipment other than the network equipment, where the other network equipment are part of the communication network and are not classified as aggressive network equipment.

In another aspect, a system as described herein can include a processor and a memory that stores executable instructions that, when executed by the processor, facilitate performance of operations. The operations can include determining a frequency of signaling events initiated by a user equipment with an authorized connection via a communication network; in response to the frequency of the signaling events being determined to be greater than a frequency threshold, classifying the user equipment as a restricted device; and in response to the user equipment being classified as the restricted device, assigning the user equipment to a first mobility management function, where the first mobility management function accepts a first proportion of first attach requests, which were transmitted by the user equipment to the first mobility management function, that is lower than a second proportion of second attach requests accepted by a second mobility management function, distinct from the first mobility management function, that serves non-restricted devices via the communication network.

In a further aspect, a non-transitory machine-readable medium as described herein can include executable instructions that, when executed by a processor, facilitate performance of operations. The operations can include identifying a signaling frequency associated with a network device associated with a communication network; classifying the network device as an aggressive device in response to the signaling frequency being greater than a threshold; and assigning the network device to a first mobility management function in response to the network device being classified as the aggressive device, where the first mobility management function is associated with a first attach request acceptance rate that is lower than a second attach request acceptance rate associated with a second mobility management function that is different from the first mobility management function and serves non-aggressive network devices associated with the communication network.

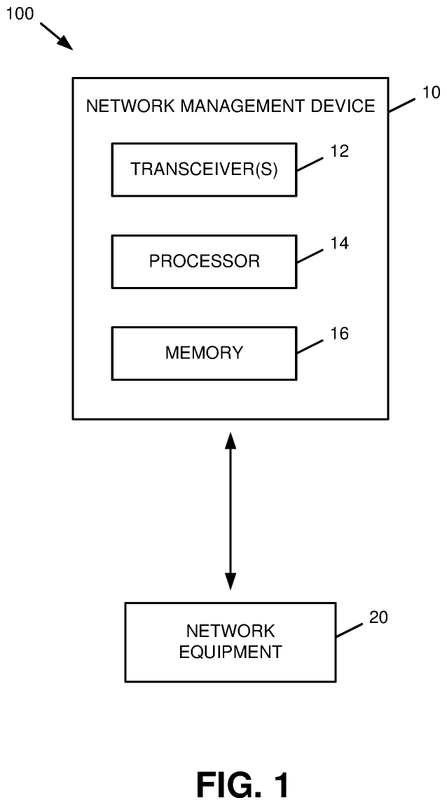

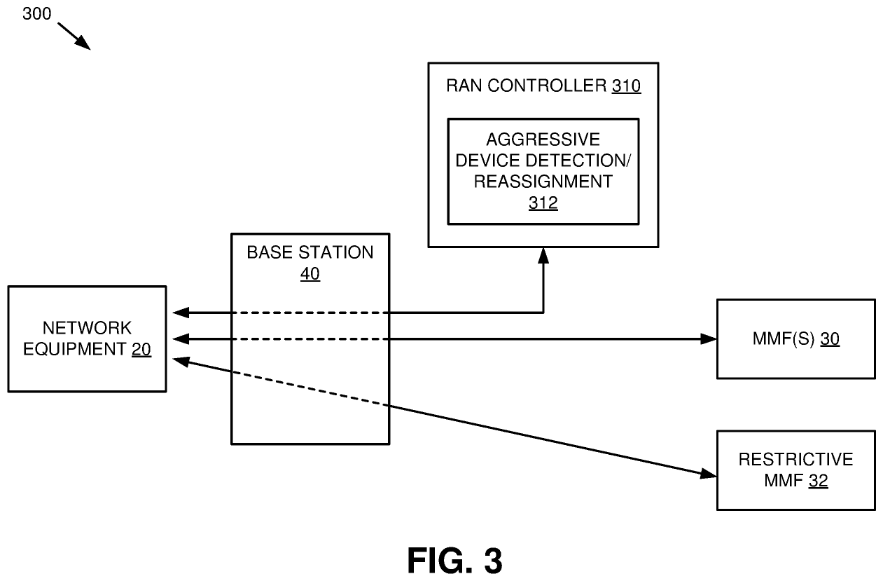

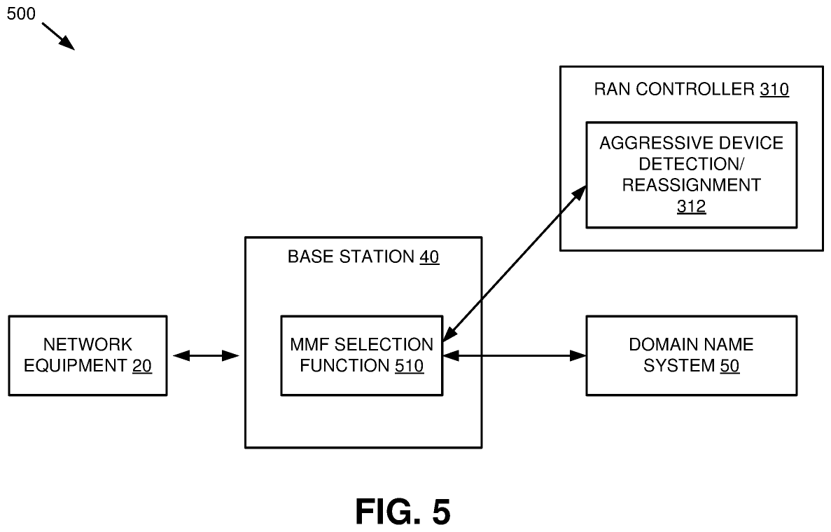

Referring first to FIG. 1, a system 100 that facilitates mobility management for aggressive devices is illustrated. System 100 as shown by FIG. 1 includes a network management device 10 that can communicate with network equipment 20, e.g., one or more mobile devices. In an aspect, the network management device 10 can be implemented by one or more network controllers and/or other devices, e.g., devices associated with a core network, that manage communication between devices of an underlying wireless communication network. The network management device 10, when implemented in this manner, can reside on the same communication network as the network equipment 20 or on a different network (e.g., such that the controller can communicate with respective network devices via a separate system). By way of example, the network management device 10 can include, or have the functionality of, an Open Radio Access Network (Open RAN or O-RAN) RAN Intelligent Controller (RIC) and/or any other RAN controller device that provides core network control functionality for the underlying network. Examples of a network management device 10 implemented in this manner are described in further detail below with respect to FIGS. 3 and 5. Also or alternatively, the network management device 10 can include and/or otherwise interact with any other suitable network device or devices, such as a base station, an access point, an eNB or gNB, and/or another device that provides communication service to the network equipment 20. Other implementations of the network management device 10 are also possible.

In an aspect, the network equipment 20 can include any suitable device(s) that can communicate over a wireless communication network associated with the network management device 10. Such devices can include, but are not limited to, cellular phones, computing devices such as tablet or laptop computers, autonomous vehicles, Internet of Things (IoT) devices, etc. Also or alternatively, network equipment 20 could include a device such as a modem, a mobile hotspot, or the like, that provides network connectivity to another device (e.g., a laptop or desktop computer, etc.), which itself can be fixed or mobile.

Collectively, the network management device 10 and the network equipment 20 can form at least a portion of a wireless communication network. While only one network management device 10 and one network equipment 20 are illustrated in FIG. 1 for simplicity of illustration, it is noted that a wireless communication network can include any amount of network equipment 20 and/or other devices, such as the network management device 10, base stations, etc.

The network management device 10 shown in system 100 can include one or more transceivers 12 that can communicate with (e.g., transmit messages to and/or receive messages from) the network equipment 20 and/or other devices in system 100. The transceiver 12 can include respective antennas and/or any other hardware or software components (e.g., an encoder/decoder, modulator/demodulator, etc.) that can be utilized to process signals for transmission and/or reception by the network management device 10 and/or associated network devices such as a base station. While the network management device 10 and network equipment 20 are illustrated in FIG. 1 as engaging in direct communications, it is noted that such communication could also be indirect, e.g., via an intermediary device such as a base station, evolved Node B (eNB), next generation Node B (gNB), etc.

In an aspect, the network management device 10 can further include a processor 14 and a memory 16, which can be utilized to facilitate various functions of the network management device 10. For instance, the memory 16 can include a non-transitory computer readable medium that contains computer executable instructions, and the processor 14 can execute instructions stored by the memory 16. For simplicity of explanation, various actions that can be performed via the processor 14 and the memory 16 of the network management device 10 are shown and described below with respect to various logical components. In an aspect, the components described herein can be implemented in hardware, software, and/or a combination of hardware and software. For instance, a logical component as described herein can be implemented via instructions stored on the memory 16 and executed by the processor 14. Other implementations of various logical components could also be used, as will be described in further detail where applicable.

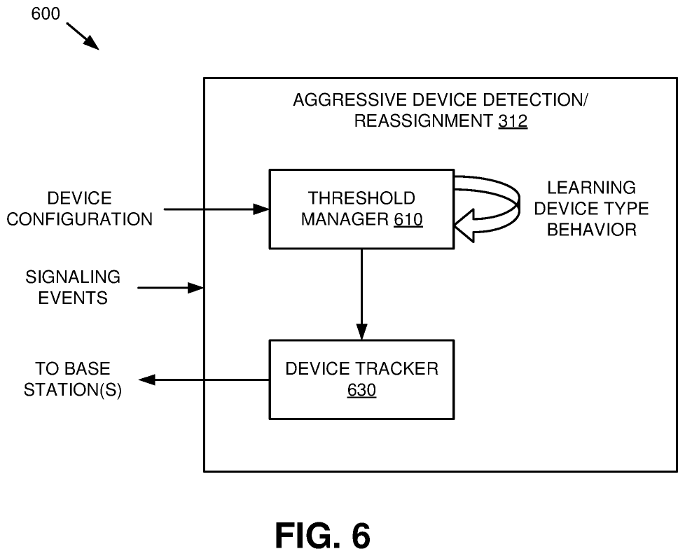

In an aspect, the processor 14 and memory 16 can be utilized to detect aggressive network equipment 20 and take appropriate actions to mitigate the impact of such devices on an associated communication network. As used herein, an “aggressive” device refers to a device that initiates an abnormally high amount of signaling events, such as network attach requests or the like, relative to the network in which the device operates. For instance, an aggressive device may engage in a signaling storm, which is a burst of signaling events of a high quantity and/or frequency that can potentially impact communication service to other network equipment due to network overloading. Techniques for classifying a device as aggressive based on a signaling threshold are described in further detail below with respect to, e.g., FIG. 6.

By implementing various embodiments as described herein, various advantages can be realized that can improve the performance of a wireless communication network and/or respective devices in the network. These advantages can include, but are not limited to, the following. Network bandwidth usage efficiency in an area can be increased. Communication network overloading caused by malfunctioning and/or malicious devices can be reduced, resulting in improved network connectivity. Network access can by aggressive network devices can be managed in a manner that reduces the impact of the aggressive network devices on the network without overly limiting access by said devices to the network. Network access by aggressive devices can also be controlled with limited to no impact on non-aggressive devices. Other advantages are also enabled by such network access.

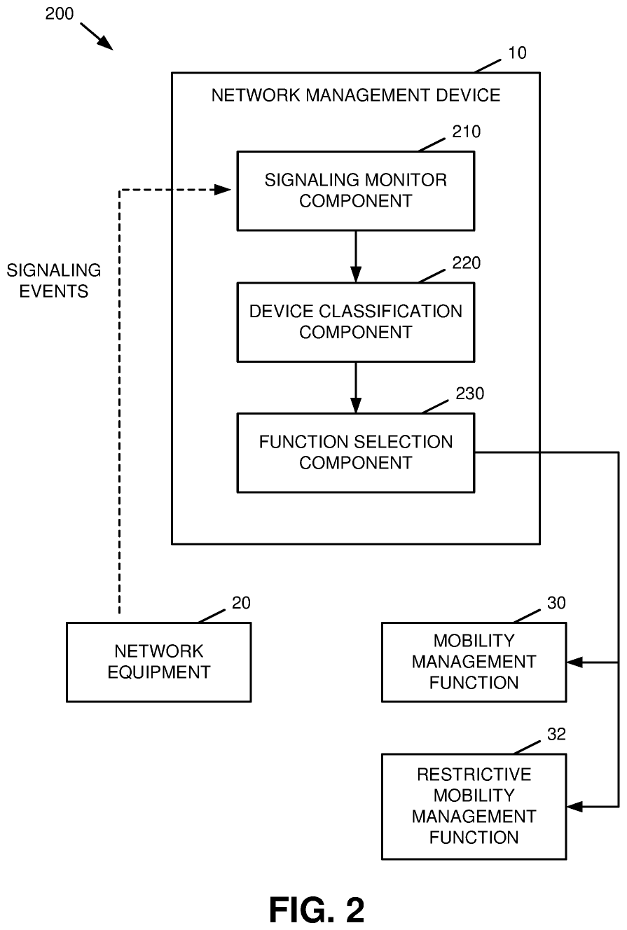

With reference now to FIG. 2, a block diagram of a system 200 that facilitates mobility management for aggressive devices in accordance with various aspects described herein is illustrated. Repetitive description of like elements employed in other embodiments described herein is omitted for sake of brevity. System 200 as shown in FIG. 2 includes a network management device 10 that can operate in a similar manner to that described above with respect to FIG. 1. As further shown in FIG. 2, the network management device 10 can communicate with network equipment 20 (network devices, user equipment devices, etc.), either directly or indirectly via one or more eNBs, gNBs, or other devices (not shown), via one or more communication networks.

In an aspect, the network equipment 20 can maintain connectivity to a network managed by the network management device 10 by exchanging signaling messages for events such as attaching to the network, changing location, initiating a data session, waking up from idle mode, and/or other suitable events. The network, in turn, can be designed to support a given volume of these signaling events, which in a typical network is significantly smaller than the volume of user data passing through the network. While network standards exist to regulate the maximum number of signaling messages a device can generate at any given time, network equipment 20 in some cases can violate these regulations, e.g., due to hardware, software or configuration faults and/or due to other causes. Furthermore, some of these faults could potentially be exploited or reproduced by attackers or other malicious users, e.g., to cause network outages by initiating a signaling storm via a compromised device and/or otherwise further increasing the volume of signaling messages in the network. This potential for network service disruption is of particular concern for IoT devices, which are generally less secure and/or more prone to malfunction than other network-connected devices.

To mitigate the risk of network service disruption described above, the network management device 10 shown in system 200 can utilize modified network functions, such as a variation of a mobility management function (MMF), that are specialized to handle aggressive network devices. This entity can be specialized to provide network service to such devices efficiently without impacting the experience of other, benign or otherwise non-aggressive devices.

As shown in FIG. 2, the network management device 10 of system 200 can include a signaling monitor component 210 that can detect a frequency of signaling events, such as network attach requests and/or other signaling that is desirably tracked by the network management device 10, that are transmitted by network equipment 20 operating as part of a communication network. The network management device 10 shown in system 200 further includes a device classification component that, in response to the signaling event frequency associated with the network equipment 20 as detected by the signaling monitor component 210 being greater than a frequency threshold, can classify the network equipment 20 as aggressive network equipment.

As further shown in FIG. 2, the network management device 10 of system 200 can additionally include a function selection component 230 that can select an MMF for use by the network equipment 20 based on the classification given to the network equipment 20 by the device classification component 220, e.g., from among a conventional MMF 30 and a specialized restrictive MMF 32. As used herein, the terms “mobility management function” and “MMF” refer to the function of a communication network that processes signaling data transmitted from network equipment 20, e.g., data associated with network access or attach requests and/or other suitable signaling events. By way of specific example, the MMF can be a Mobility Management Element (MME) (e.g., in a Long Term Evolution (LTE) network), an Access and Mobility Management Function (AMF) (e.g., in a Fifth Generation (5G) network), etc. It is noted, however, that the preceding are merely non-limiting examples and that an MMF as described herein could be any suitable network function that handles mobility management according to any communication network technology, either presently existing or developed in the future.

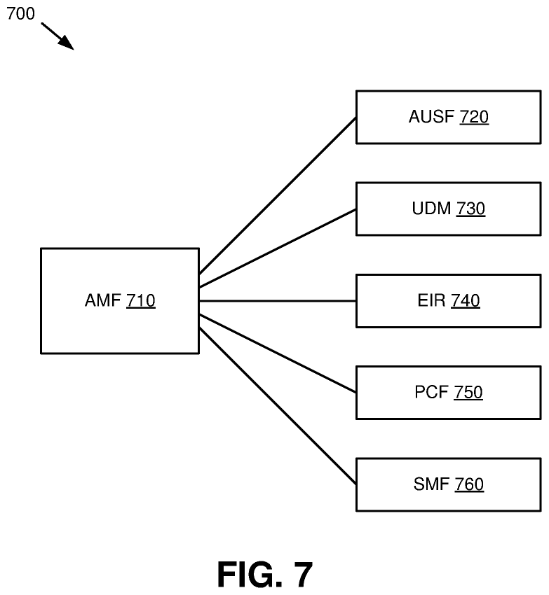

In an aspect, in response to the device classification component 220 classifying network equipment 20 as aggressive network equipment, the function selection component 230 can assign the network equipment to a restrictive MMF 32, e.g., instead of a conventional MMF 30. As will be described in further detail below, the restrictive MMF 32 can facilitate the use of one or more additional network functions by aggressive network equipment 20 that are similar to those facilitated by the conventional MMF 30 but optimized for use by aggressive devices, e.g., by accepting a lower (first) proportion of network attach requests and/or other signaling transmitted by network equipment 20 to the restrictive MMF 32 than a (second) proportion of network attach requests and/or other signaling accepted by a conventional MMF 30 that serves other, non-aggressive network equipment 20. By doing so, the restrictive MMF 32 can enable aggressive network equipment 20 to continue to access functions of the network without overloading the restrictive MMF 32 and/or other network functions associated with the restrictive MMF 32. Examples of network functions that can interact with a restrictive MMF 32 are described below with respect to FIG. 7.

Turning now to FIG. 3, a block diagram of a system 300 that facilitates implementation of a mobility management function for aggressive devices in a wireless communication network in accordance with various aspects described herein is illustrated. Repetitive description of like elements employed in other embodiments described herein is omitted for sake of brevity. As noted above, FIG. 3 illustrates an example in which the functionality of the network management device 10 and its logical components 210, 220, 230 are implemented by a RAN controller 310, such as an open radio access network (O-RAN) RAN intelligent controller (RIC) and/or any other suitable network controller device, via an aggressive device detection/reassignment module 312. It is noted, however, that the example shown by FIG. 3 is merely one implementation that could be used, and that other implementations are also possible.

As shown by FIG. 3, network equipment 20 can access a communication network via a serving base station 40 (access point, eNB, gNB, etc.) for the network equipment 20, e.g., based on techniques for associating network equipment with a base station and/or other network elements as known in the art. For instance, the network equipment 20 can transmit respective signaling messages to the base station 40, which can be forwarded from the base station to one or more core network elements, such as a RAN controller 310 and/or MMFs 30, 32, via a backhaul link between the base station 40 and the respective core network elements and/or by any other suitable wired or wireless communication techniques.

In an aspect, signaling messages sent by network equipment 20 to the base station 40 can be monitored to determine their frequency, e.g., by a signaling monitor component 210 as described above. This monitoring can be performed by the base station 40 for the network equipment 20, or alternatively a network packet analyzer and/or other suitable network entities can be utilized to perform the monitoring. Information relating to the frequency of signaling events can then be provided to an aggressive device detection/reassignment module 312 associated with a RAN controller 310 that provides network monitoring and control functionality for the underlying communication network or a portion of the network (e.g., a portion corresponding to a geographical region, etc.).

The aggressive device detection/reassignment module 312 shown in system 300 can detect aggressive devices and facilitate their assignment to a restrictive MMF 32, e.g., instead of an MMF 30 of a group of conventional MMFs associated with the network. In an aspect, the MMFs 30 and the restrictive MMF 32 shown in system 300 can comprise a set of MMFs associated with a geographical region in which the network equipment 20 and base station 40 operate. For instance, an MMF (or multiple MMFs) in a given geographical region can be designated as a restrictive MMF 32 for the region and configured to process aggressive devices as generally described herein, while the remaining MMFs 30 of the region can continue to operate as standard MMFs. Other implementations are possible.

In an aspect, the aggressive device detection/reassignment module 312 can facilitate reassignment of given network equipment 20 to and/or from a restrictive MMF 32 by monitoring (directly or indirectly) the signaling of the network equipment 20 and instructing the serving base station 40 (eNB, gNB, etc.) to perform the appropriate assignment. In an example, the aggressive device detection/reassignment module 312 can detect an amount of signaling associated with network equipment 20 by counting a number of signaling events (e.g., attach requests, etc.) for each device of the network equipment 20 and alerting the base station 40 of those devices that exceed a given threshold (e.g., more than 10-20 attaches per minute to the network, etc.).

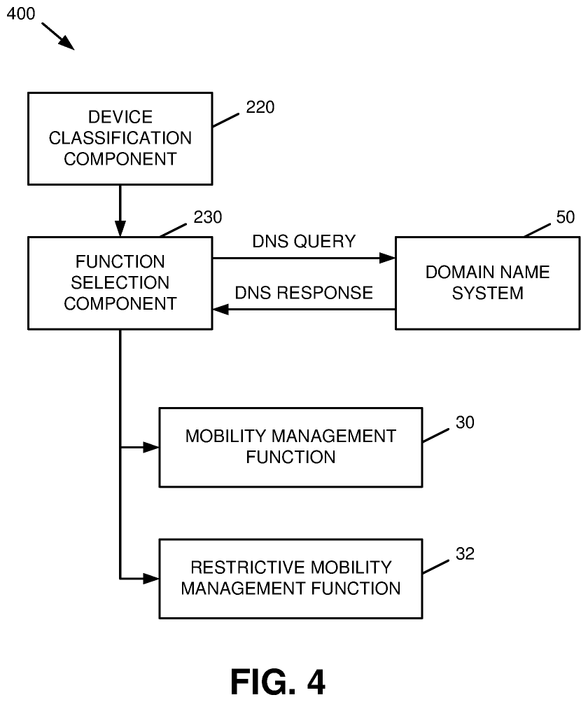

With reference next to FIG. 4, a block diagram of a system 400 that facilitates assignment of network equipment 20 to an MMF 30, 32 via a domain name system 50 in accordance with various aspects described herein is illustrated. Repetitive description of like elements employed in other embodiments described herein is omitted for sake of brevity. As shown in FIG. 4, a device classification component 220 can provide a classification for network equipment 20 to a function selection component 230.

The classification provided by the device classification component 220 as shown in system 400 can also instruct the function selection component 230 to submit a query to a domain name system 50, such as an information-centric domain name system (iDNS) or the like, based on the result of the classification. Thus, for example, if the device classification component 220 classifies given network equipment 20 as non-aggressive, the device classification component 220 can instruct the function selection component 230 to provide a query to the domain name system 50 according to one or more techniques known in the art, which can result in the assignment of the network equipment to a standard MMF 30. Alternatively, if the network equipment 20 has been classified as aggressive, the device classification component 220 can instruct the function selection component 230 to alter the query to include an indication that the network equipment 20 is classified as aggressive network equipment. As a result of this modified query, the domain name system 50 can provide a response to the function selection component that facilitates assignment of the network equipment to the restrictive MMF 32 instead of a standard MMF 30.

Turning next to FIG. 5, a block diagram of a system 500 is illustrated that further shows the domain name service (DNS) query operations described above with reference to FIG. 4 in the context of the network architecture shown in FIG. 3. Here, the device classification component 220 shown in FIG. 4 can be implemented wholly or in part by the aggressive device detection/reassignment module 312 of the RAN controller 310, and the function selection component 230 shown in FIG. 4 can be implemented wholly or in part by an MMF selection function 510 implemented by a serving base station 40 (eNB, gNB, etc.) for the network equipment 20. It is noted, however, that other implementations could also be used.

In an aspect, the MMF selection function 510 of the base station 40 can query the domain name system 50 by sending a tracking area identifier (TAI) of the network equipment 20. In response, the domain name system 50 can return a set of available nearby MMF servers, e.g., MMFs 30 (not shown in FIG. 5). Additionally, in the event that the aggressive device detection/reassignment module 312 of the RAN controller 310 has classified the network equipment 20 as aggressive, the RAN controller 310 can inform the MMF selection function 510 to send a modified query that requests the address of a restrictive MMF 32 (not shown in FIG. 5) from the domain name system 50.

In an aspect, the MMF selection function 510 can alter a query to the domain name system 50 for aggressive network equipment 20 by specifying a keyword or other appropriate indicator in the query. By way of specific, non-limiting example, a query provided by the MMF selection function 510 to the domain name system 50 for a standard MMF can be structured as follows (with line breaks added for formatting purposes):

tac-lb<TAC-low-byte>.tac-hb<TAC-high-byte>.tac.epc.mnc<MNC>
.mcc<MCC>.3gppnetwork.org

In the above example, TAC is a tracking area code, MNC is a mobile network code, and MCC is a mobile carrier code. In the event that network equipment 20 is classified as aggressive, the query can be modified to include the keyword “aggressive” as follows (with line breaks added for formatting purposes):

tac-lb<TAC-low-byte>.tac-hb<TAC-high-byte>.tac.epc.mnc<MNC>
.mcc<MCC>.aggressive.3gppnetwork.org

As a result of this modified query, the domain name system 50 can return the address of a restrictive MMF 32 associated with the network and/or region in which the base station 40 operates, e.g., instead of a standard MMF 30.

Referring now to FIG. 6, diagram 600 illustrates the operation of the aggressive device detection/reassignment module 312 shown in FIGS. 3 and 5 in further detail. As noted above, the aggressive device detection/reassignment module 312 can the volume of signaling messages generated by respective network equipment 20 to determine whether any devices of the network equipment 20 exceed a given frequency threshold. In an aspect, this threshold can be set according to values derived from applicable network standards, such as Third Generation Partnership Project (3GPP) standards or the like. For instance, the threshold can be initially set based on a determination that a device should not attach to the network more than a given number of times (e.g., 5, 10, 20, etc.) in a minute.

As further shown in diagram 600, the aggressive device detection/reassignment module 312 can include a threshold manager 610 that can adjust a given signaling frequency threshold for certain types of devices based on special requirements associated with those types of devices, past device behavior, network usage and/or loading patterns, regional considerations, and/or other factors. In an aspect, the threshold manager 610 can maintain separate thresholds for different subsets of devices. These thresholds can be determined by manual configuration (e.g., by a network operator), by utilizing machine learning techniques to learn typical behavior of given device types during times where the network is not overloaded, and/or by other means. By way of example, a threshold assigned to network-connected automobiles can be higher than that assigned to other device classes due to safety considerations associated with denying service to a connected automobile for extended periods of time. In an aspect, the threshold manager 610 can provide respective determined thresholds to a device tracker 620, as will be discussed below.

In an aspect, the threshold manager 610 can set frequency thresholds for respective network equipment 20, base stations 40, and/or other network elements on a per-element basis. For instance, a threshold set by the threshold manager 610 for a given geographical region can be based on a number of aggressive devices reported to be operating in the region. By way of example, a frequency threshold for assigning network equipment 20 to a restrictive MMF 32 can be decreased by the threshold manager 610 in response to an increase in the overall number of aggressive devices present in the region.

In another aspect, a signaling frequency threshold can be assigned by the threshold manager 610 for a given base station 40 based on expected signaling activity by devices served by that base station 40. For instance, a base station 40 that serves an airport or other major transit center can be configured with a frequency threshold that is more lenient than that associated with other base stations 40 because of expected signaling bursts associated with user devices arriving at and/or departing from the transit center. Other similar examples are also possible.

The device tracker 620 shown in diagram 600 can identify respective devices of associated network equipment 20 that exceed the signaling rate threshold determined by the threshold manager 610. Information relating to this list can be provided, e.g., in real time or near real time, to respective serving base stations 40 for the network equipment in order to facilitate assignment of the network equipment to appropriate MMFs 30 and/or restrictive MMFs 32, e.g., by utilizing a domain name system as described above with respect to FIGS. 4-5.

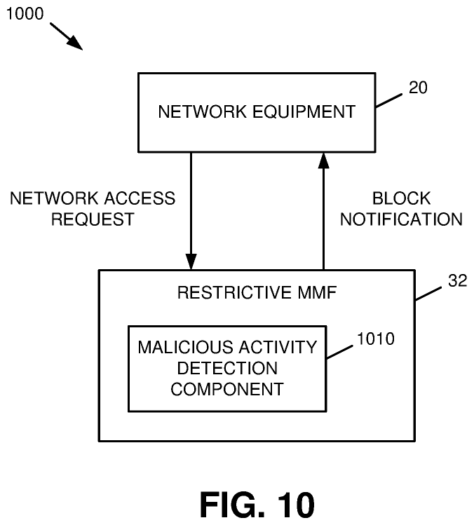

In an aspect, a restrictive MMF 32 can be an MMF (e.g., an AMF, a MME, etc.) that is modified to more efficiently handle aggressive devices. Rather than merely blocking aggressive devices, the restrictive MMF 32 can be configured to still provide service to aggressive devices that are associated with benign users, e.g., devices that are aggressive due to a design fault, devices that are compromised by an attacker without the knowledge of the user, etc. Techniques that can be utilized by a restrictive MMF 32 in response to malicious users and/or activity are described in further detail below with respect to FIG. 10.

In another aspect, a restrictive MMF 32 as described herein can facilitate a significant reduction in network signaling associated with a network attach event or other signaling event. For instance, a network attach event can generate of a large number of signaling messages (e.g., approximately 100 messages) and involve several network functions. By way of example, diagram 700 in FIG. 7 illustrates the various network functions with which a 5G AMF 710 can interact during a typical signaling event. While the network functions shown in diagram 700 are specific to 5G networks, it is noted that similar network functions could also be used for other network technologies.

As shown in diagram 700, an attach event for a device in a 5G core network initially involves the AMF 710. The AMF 710 can then interact with an Authentication Server Function (AUSF) 720 and a Unified Data Management entity (UDM) 730 to authenticate the device and a 5G Equipment Identity Register (EIR) 740 to verify that the device is not blacklisted. If the device is not blacklisted, the AMF 710 can again leverage the UDM 730 to register the device and obtain subscription data. Additionally, the AMF can involve a Policy Control Function (PCF) 750 to update applicable device policies and a Session Management Function (SMF) 760 to set up the user plane function for the device.

In an aspect, a restrictive MMF 32 can perform various measures to facilitate access to network services by aggressive devices while avoiding overload conditions. For instance, a restrictive MMF 32 can set up a stricter threshold of accepted requests per device than a standard MMF 30 due to all of the devices handled by the restrictive MMF 32 being classified as aggressive. This can be accomplished via any suitable techniques for limiting the amount of signaling requests from an aggressive device, e.g., as compared to a non-aggressive device.

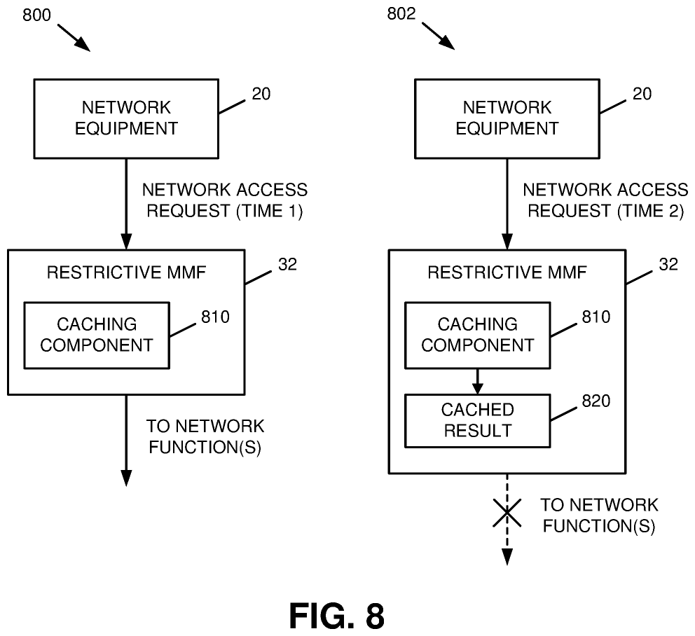

As an example of the above, diagrams 800 and 802 in FIG. 8 illustrate a system in which a restrictive MMF 32 can utilize caching to avoid generating redundant queries to different network elements. As first shown by diagram 800, a restrictive MMF 32 can relay a first network attach request, e.g., a network attach request received from network equipment 20 at a first time, to one or more distinct network functions (e.g., as described above with respect to FIG. 7, etc.). Subsequently, a caching component 810 of the restrictive MMF 32 can cache a result of the first network attach request as received from the associated network function(s). Subsequently, as shown by diagram 802, the restrictive MMF 32 can respond to a second network attach request transmitted by the network equipment 20 within a threshold time of the first network attach request by applying a cached result 820 of the first network attach request, e.g., instead of relaying the second network attach request to the distinct network function(s). As a result, the restrictive MMF 32 can facilitate network access to aggressive network equipment 20 without re-authenticating the network equipment 20 in response to every received attach request.

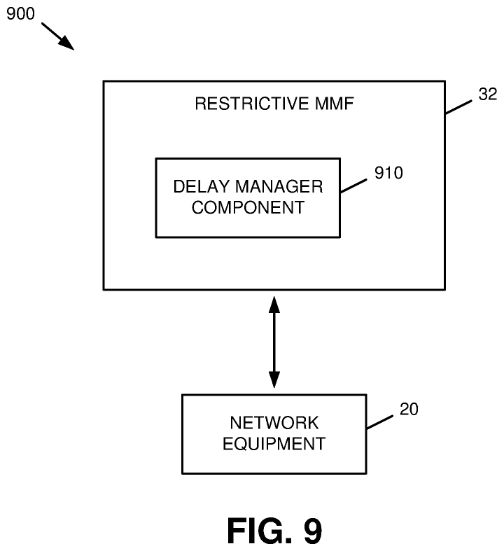

In another example, system 900 in FIG. 9 illustrates a restrictive MMF 32 that can compute and assign a time delay to aggressive network equipment via a delay manager component 910. In an aspect, the delay manager component 910 can deny respective network attach requests that are transmitted by aggressive network equipment 20 within a threshold time starting from an initial network attach request. In an aspect, a time delay as applied to network equipment 20 by the delay manager component 910 can be used in combination with request caching, e.g., as described above with respect to FIG. 8. Alternatively, the delay manager component 910 can facilitate blocking access requests that are received within a threshold time of an initial access request. As still another example, the delay manager component 910 can refrain from involving one or more other network functions, such as those shown in FIG. 7, in processing an access request received within a threshold time of an initial access request. Other operations could also be used.

In an aspect, a time delay assigned by the delay manager component 910 can be a uniform delay, or alternatively the time delay can be dynamically set based on the number of aggressive network devices served by the restrictive MMF 32 and/or based on other factors. Additionally or alternatively, the delay manager component 910 can assign a time delay to respective network equipment 20 that increases with subsequent signaling attempts. As a result, the restrictive MMF 32 can apply measures to a given device of network equipment 20 that is proportional to the amount of aggression of that device toward the network.

With reference again to FIG. 3, in the event that the aggressive device detection/reassignment module 312 determines that given network equipment 20 is no longer acting aggressively, it can update a serving base station 40 for the device, e.g., by removing the network equipment 20 from a list of aggressive devices maintained by the network. The aggressive device detection/reassignment module 312 can also facilitate reassignment of the network equipment 20 from a restrictive MMF 32 to a standard MMF 30, e.g., by sending a paging message to the network equipment 20 through its serving base station 40 to initiate a Tracking Area Update (TAU) at the network equipment 20. The paging message, in turn, can cause the network equipment 20 to send a TAU Request message to its serving base station 40. The TAU can then result in the network equipment 20 being assigned, or reassigned, to a standard MMF 30 instead of the restrictive MMF 32.

Turning now to FIG. 10, a block diagram of a system 1000 that facilitates detection and mitigation of malicious communication network activity in accordance with various aspects described herein is illustrated. Repetitive description of like elements employed in other embodiments described herein is omitted for sake of brevity. As shown in FIG. 10, the restrictive MMF 32 of system 1000 includes a malicious activity detection component 1010 that can determine whether network equipment 20 is engaging in malicious activity. In an aspect, the malicious activity detection component 1010 can distinguish between benign device activity and malicious activity based on an observed pattern of signaling events initiated by the network equipment 20, malware infection and/or other indicators that the network equipment 20 is compromised, and/or any other suitable criteria.

In response to determining that network equipment 20 is engaging in malicious behavior, the malicious activity detection component 1010 can apply a specialized policy for malicious devices that blocks access to the network equipment 20 from access to services associated with the underlying communication network. By way of example, the malicious activity detection component 1010 can send malicious network equipment 20 an error code or other notification that blocks the network equipment 20 from the network for a defined period of time. Other methods of blocking network access by malicious network equipment 20 could also be used by the malicious activity detection component 1010.

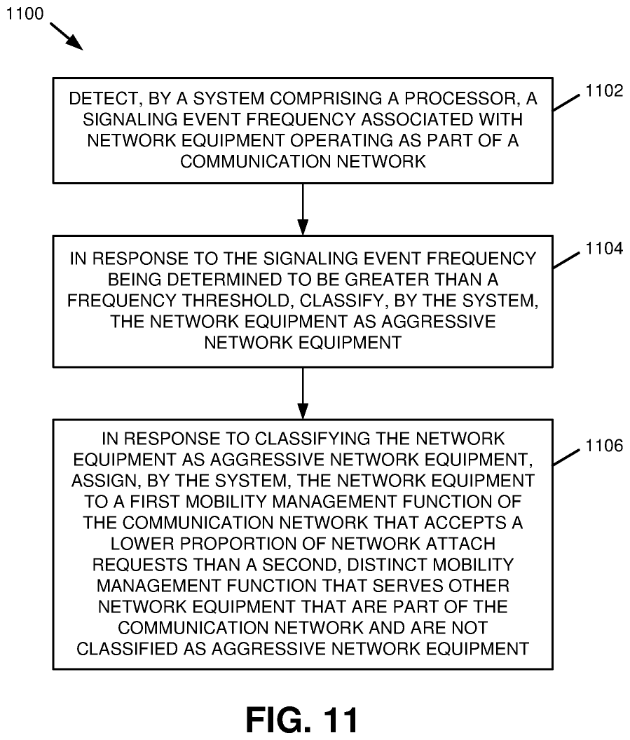

FIG. 11 illustrates a method in accordance with certain aspects of this disclosure. While, for purposes of simplicity of explanation, the method is shown and described as a series of acts, it is noted that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain aspects of this disclosure.

With reference to FIG. 11, a flow diagram of a method 1100 that facilitates mobility management for aggressive devices in accordance with various aspects described herein is presented. At 1102, a system comprising a processor (e.g., a network management device 10 comprising a processor 14, and/or a system including such a device) can detect (e.g., by a signaling monitor component 210 and/or other components implemented by the processor 14) a signaling event frequency associated with network equipment (e.g., network equipment 20) operating as part of a communication network.

At 1104, in response to the signaling event frequency as detected at 1102 being determined to be greater than a frequency threshold, the system can classify (e.g., by a device classification component 220 and/or other components implemented by the processor 14) the network equipment as aggressive network equipment.

At 1106, in response to the network equipment being classified as aggressive network equipment at 1104, the system can assign (e.g., by a function selection component 230 and/or other components implemented by the processor 14) the network equipment to a first MMF (e.g., a restrictive MMF 32). In an aspect, the first MMF can accept a lower proportion of network attach requests and/or other signaling than a second proportion of similar signaling that is accepted by a second MMF (e.g., a standard MMF 30) that serves other network equipment in the communication network that is not classified as aggressive network equipment.

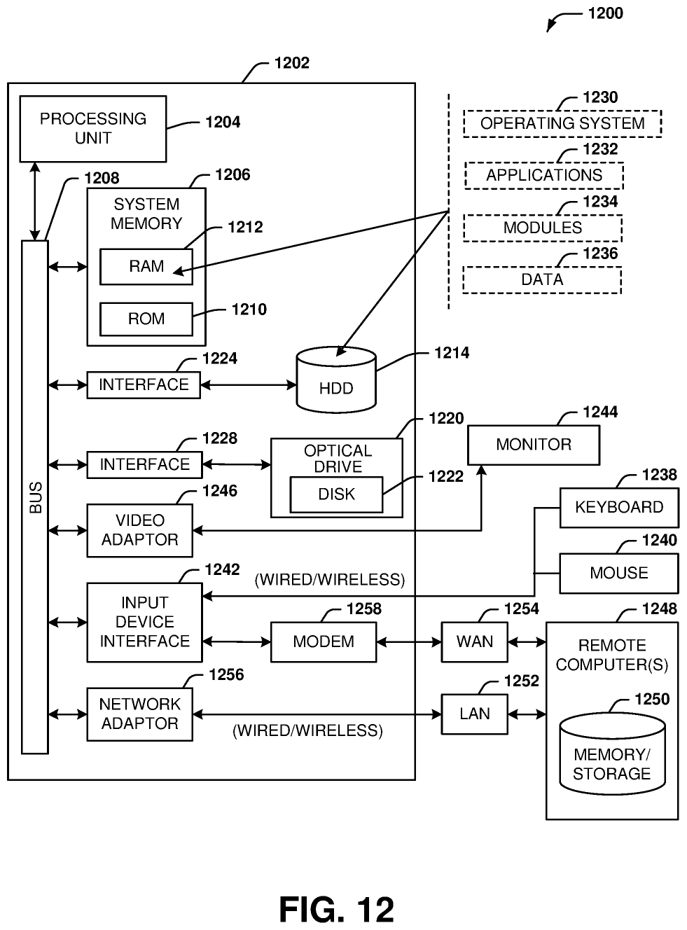

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 and an optical disk drive 1220, (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214 and optical disk drive 1220 can be connected to the system bus 1208 by an HDD interface 1224 and an optical drive interface 1228, respectively. The HDD interface 1224 can additionally support external drive implementations via Universal Serial Bus (USB), Institute of Electrical and Electronics Engineers (IEEE) 1394, and/or other interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it is noted by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) can include a microphone, an infrared (IR) remote control, a joystick, a game pad, a stylus pen, touch screen or the like. These and other input devices are often connected to the processing unit 1204 through an input device interface 1242 that can be coupled to the system bus 1208, but can be connected by other interfaces, such as a parallel port, an IEEE 1394 serial port, a game port, a USB port, an IR interface, a BLUETOOTH® interface, etc.

A monitor 1244 or other type of display device can be also connected to the system bus 1208 via an interface, such as a video adapter 1246. In addition to the monitor 1244, a computer typically includes other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1252 through a wired and/or wireless communication network interface or adapter 1256. The adapter 1256 can facilitate wired or wireless communication to the LAN 1252, which can also include a wireless access point (AP) disposed thereon for communicating with the wireless adapter 1256.

When used in a WAN networking environment, the computer 1202 can include a modem 1258 or can be connected to a communications server on the WAN 1254 or has other means for establishing communications over the WAN 1254, such as by way of the Internet. The modem 1258, which can be internal or external and a wired or wireless device, can be connected to the system bus 1208 via the input device interface 1242. In a networked environment, program modules depicted relative to the computer 1202 or portions thereof, can be stored in the remote memory/storage device 1250. It will be appreciated that the network connections shown are example and other means of establishing a communications link between the computers can be used.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10BaseT wired Ethernet networks used in many offices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
detecting, by a system comprising a processor, a signaling event frequency associated with network equipment operating as part of a communication network;
in response to the signaling event frequency being determined to be greater than a frequency threshold, classifying, by the system, the network equipment as aggressive network equipment; and
in response to classifying the network equipment as aggressive network equipment, assigning, by the system, the network equipment to a first mobility management function of the communication network, wherein the first mobility management function accepts a first proportion of first network attach requests received by the first mobility management function from the network equipment, and wherein the first proportion is lower than a second proportion of second network attach requests accepted by a second mobility management function, distinct from the first mobility management function, that serves other network equipment other than the network equipment, wherein the other network equipment are part of the communication network and are not classified as aggressive network equipment.

2. The method of claim 1, further comprising:
instructing, by the system, a mobility management function selection function to submit a query to a domain name system in response to classifying the network equipment as aggressive network equipment; and
obtaining, by the system, an identity of the first mobility management function in response to the query.

3. The method of claim 2, wherein the query comprises an indication that the network equipment has been classified as aggressive network equipment.

4. The method of claim 1, further comprising:
in response to the signaling event frequency being determined to have fallen below the frequency threshold, reassigning, by the system, the network equipment from the first mobility management function to the second mobility management function.

5. The method of claim 4, wherein reassigning the network equipment to the second mobility management function comprises:
initiating a tracking area update at the network equipment by transmitting a paging message to the network equipment; and
reassigning the network equipment to the second mobility management function as a result of the tracking area update.

6. The method of claim 1, further comprising:
causing, by the system, the first mobility management function to relay a first network attach request, received by the first mobility management function from the network equipment, to a distinct network function; and
caching, by the system, a result of the first network attach request received from the distinct network function, resulting in a cached result.

7. The method of claim 6, further comprising:
in response to determining that the first mobility management function has received a second network attach request from the network equipment within a threshold time starting from the first network attach request, causing, by the system, the first mobility management function to apply the cached result to the second network attach request instead of relaying the second network attach request to the distinct network function.

8. The method of claim 1, further comprising:
determining, by the system, that the network equipment is engaging in malicious behavior based on an observed pattern of signaling events initiated by the network equipment; and
in response to determining that the network equipment is engaging in the malicious behavior, causing the first mobility management function to respond to a network attach request of the first network attach requests with an indication that the network equipment is blocked from access to services associated with the communication network.

9. The method of claim 1, further comprising:
causing, by the system, the first mobility management function to deny respective ones of the first network attach requests that are transmitted by the network equipment to the first mobility management function within a threshold time starting from a first network attach request of the first network attach requests.

10. A system, comprising:
a processor; and
a memory that stores executable instructions that, when executed by the processor, facilitate performance of operations, the operations comprising:
determining a frequency of signaling events initiated by a user equipment with an authorized connection via a communication network;
in response to the frequency of the signaling events being determined to be greater than a frequency threshold, classifying the user equipment as a restricted device; and
in response to the user equipment being classified as the restricted device, assigning the user equipment to a first mobility management function, wherein the first mobility management function accepts a first proportion of first attach requests, which were transmitted by the user equipment to the first mobility management function, that is lower than a second proportion of second attach requests accepted by a second mobility management function, distinct from the first mobility management function, that serves non-restricted devices via the communication network.

11. The system of claim 10, wherein the operations further comprise:
in further response to the user equipment being classified as the restricted device, causing a mobility management function selection function to submit a query to a domain name system, wherein assigning the user equipment to the first mobility management function comprises routing the user equipment to the first mobility management function based on a result of the query as received from the domain name system.

12. The system of claim 10, wherein the operations further comprise:
in response to the frequency of the signaling events being determined to have fallen below the frequency threshold, reassigning the user equipment from the first mobility management function to the second mobility management function.

13. The system of claim 12, wherein reassigning the user equipment comprises:
initiating a tracking area update at the user equipment via a paging message transmitted to the user equipment; and
reassigning the user equipment to the second mobility management function as a result of the tracking area update.

14. The system of claim 10, wherein the operations further comprise:
providing first data, received by the first mobility management function from the user equipment, to a different network function, the first data relating to a first attach request initiated by the user equipment; and
caching second data received from the different network function in response to providing the first data to the different network function.

15. The system of claim 14, wherein the operations further comprise:
in response to the user equipment initiating a second attach request within a threshold time from the first attach request having been made, facilitating use of the second data by the first mobility management function instead of providing third data relating to the second attach request, received by the first mobility management function from the user equipment, to the different network function.

16. A non-transitory machine-readable medium comprising executable instructions that, when executed by a processor, facilitate performance of operations, the operations comprising:
identifying a signaling frequency associated with a network device associated with a communication network;
classifying the network device as an aggressive device in response to the signaling frequency being greater than a threshold; and
assigning the network device to a first mobility management function in response to the network device being classified as the aggressive device, wherein the first mobility management function is associated with a first attach request acceptance rate that is lower than a second attach request acceptance rate associated with a second mobility management function that is different from the first mobility management function and serves non-aggressive network devices associated with the communication network.

17. The non-transitory machine-readable medium of claim 16, wherein the operations further comprise:
identifying the first mobility management function as a result of a query submitted by a mobility management function selection function to a domain name system.

18. The non-transitory machine-readable medium of claim 16, wherein the operations further comprise:
reassigning the network device from the first mobility management function to the second mobility management function in response to the signaling frequency being determined to have decreased below the threshold.

19. The non-transitory machine-readable medium of claim 16, wherein the operations further comprise:
providing at least a portion of a first attach request, initiated by the network device from the first mobility management function, to a third network function; and
caching a result of the first attach request as received from the third network function, resulting in a cached result.

20. The non-transitory machine-readable medium of claim 19, wherein the operations further comprise:
in response to the first mobility management function receiving a second attach request from the network device within a threshold time from when the first attach request was made, facilitating use of the cached result by the first mobility management function instead of relaying any of the second attach request to the third network function.
